(19) United States
(12) Patent Application Publication
(10) Pub. No.: US 2013/0218620 A1
(43) Pub. Date: Aug. 22, 2013

(54) METHOD AND SYSTEM FOR SKILL EXTRACTION, ANALYSIS AND RECOMMENDATION IN COMPETENCY MANAGEMENT

(71) Applicants: HUA LIU, Fairport, NY (US); Yasmine Charif, Rochester, NY (US)

(72) Inventors: HUA LIU, Fairport, NY (US); Yasmine Charif, Rochester, NY (US)

(73) Assignee: Xerox Corporation, Norwalk, CT (US)

(21) Appl. No.: 13/401,413

(22) Filed: Feb. 21, 2012

(51) Int. Cl. G06Q 10/06

(52) U.S. Cl. 705/7.14

(57) ABSTRACT

A method, non-transitory computer readable medium and apparatus for performing competency management on a work flow are disclosed. For example, the method receives the work flow, wherein the work flow comprises a plurality of components, identifies a human task component of the plurality of the components of the work flow, extracts, via a processor, a set of skills required for the human task component, matches, via the processor, the set of skills to a signature and finds, via the processor, a candidate based on the signature that matches the set of skills.

The present disclosure relates generally to improving competency-based management and, more particularly, to a method, a non-transitory computer readable medium, and an apparatus for skill extraction, analysis and providing a recommendation in competency management.

### BACKGROUND

Competency-based management processes are top-down organizational processes that cannot be exploited to support team building operations in informal work activities. In many organizations, competency-based management is a manual process where jobs are assigned to workers by managers who normally do the mapping on paper. In addition, recruitment and training processes are triggered at strategy planning meetings. This process inherits the weakness of many manual processes such as slow adaptation and inaccuracy.

### SUMMARY

According to aspects illustrated herein, there are provided a method, a non-transitory computer readable medium and an apparatus for performing competency management on a work flow. One disclosed feature of the embodiments is a method that receives the work flow, wherein the work flow comprises a plurality of components, identifies a human task component of the plurality of the components of the work flow, extracts, via a processor, a set of skills required for the human task component, matches, via the processor, the set of skills to a signature and finds, via the processor, a candidate based on the signature that matches the set of skills.

Another disclosed feature of the embodiments is a non-transitory computer-readable medium having stored thereon a plurality of instructions, the plurality of instructions including instructions which, when executed by a processor, cause the processor to perform a method that receives the work flow, wherein the work flow comprises a plurality of components, identifies a human task component of the plurality of the components of the work flow, extracts, via a processor, a set of skills required for the human task component, matches, via the processor, the set of skills to a signature and finds, via the processor, a candidate based on the signature that matches the set of skills.

Another disclosed feature of the embodiments is an apparatus for performing competency management on a work flow comprising a processor and a computer readable medium having stored thereon a plurality of instructions, including instructions which, when executed by the processor, cause the processor to perform a method that receives the work flow, wherein the work flow comprises a plurality of components, identifies a human task component of the plurality of the components of the work flow, extracts, via a processor, a set of skills required for the human task component, matches, via the processor, the set of skills to a signature and finds, via the processor, a candidate based on the signature that matches the set of skills.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network of the present disclosure;

FIG. 2 illustrates an example work flow of the present disclosure

FIG. 3 illustrates an example flowchart of one embodiment of a method for performing competency management on a work flow; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, a non-transitory computer readable medium and an apparatus for performing competency management on a work flow. As discussed above, competency management is typically a manual process that takes a top-down approach. As a result, manual competency management is inefficient, has slow adaptation and susceptible to inaccuracy.

In one embodiment of the present disclosure, automated competency management is provided using algorithms that take a bottom-up approach. For example, the algorithms may analyze skills to discover hidden knowledge such as relevant skills and common skills, organize and recommend workers with the closest matching skills and levels and suggest recruitment for missing, but highly demanded skills and training for workers.

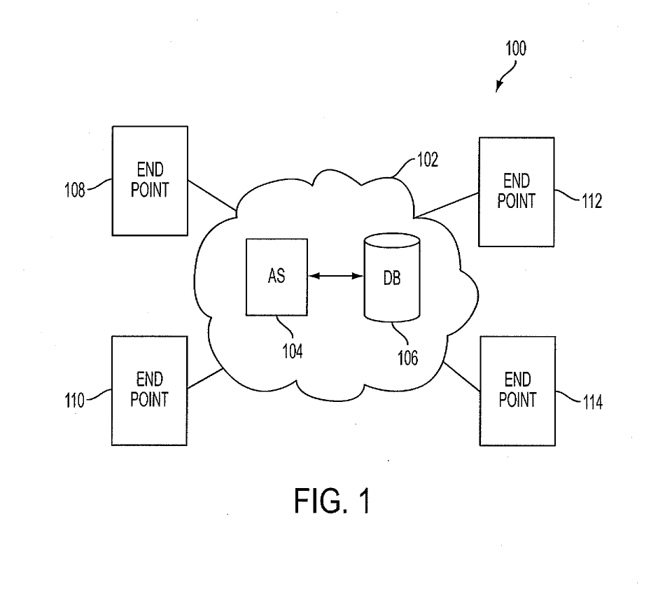

To better understand the present disclosure, FIG. 1 illustrates an example of a communications network 100. In one embodiment, the communications network 100 includes an Internet Protocol (IP) network 102. The IP network 102 may be, for example, the Internet, a service provider network, a local area network (LAN) within a company location, an access network, a core network and the like.

In one embodiment, the IP network 102 may include a general purpose application server (AS) 104 and a database (DB) 106. In one embodiment, the AS 104 may be configured to execute a business process management (BPM) platform that enables the design and execution of work flows discussed below. In addition, the AS 104 may be configured to execute the methods and algorithms described herein and discussed in further detail below. It should be noted that although only a single AS 104 is illustrated in FIG. 1, that any number of application servers may be deployed.

In one embodiment, the DB 106 may store service mappings and parameters associated with components used for designing a work flow via the BPM platform. In one embodiment, the service mappings and parameters are pre-registered in the DB 106. In one embodiment, the service mappings and parameters may be organized under one of a plurality of class types.

In one embodiment, the DB 106 may also store all the employees and associated information of the employees of an enterprise. For example, the associated information of each employee may include identification information, educational background of the employee, work experience of the employee, the employee's skills, employee clusters or groups associated with the employee, and the like.

In one embodiment, the DB 106 may also store signatures that are precalculated. In one embodiment, signatures include one or more skills that are associated with a particular task. Employees' skills may be analyzed and then grouped into a signature based upon their skills and the skills in a particular signature. The signatures may change as new employees are hired with new skills or as employees are trained. How the signatures are determined is discussed in further detail below.

The signatures may include different types of skill, such as for example, common skills and relevant skills. In one embodiment, common skills refer to skills possessed by a majority of the employees. In one embodiment, relevant skills are those skills related to another skill. This may help to identify those employees that may quickly learn other skills relative to other employees not having the relevant skills. For example, if an employee has skill “x”, this employee can learn skills that are relevant to skill “x” more quickly than other employees who do not have the skill “x”.

In one embodiment, the search set is greatly reduced by grouping the employees into the precalculated signatures and the efficiency of finding a candidate for a particular task is greatly improved. For example, instead of being required to search iteratively through each one of a list of 100,000 employees, the process may only require to search iteratively through each one of a list of 100 signatures pertaining to the list of 100,000 employees. When a signature is found, the signature may then include employees who may be possible candidates for a particular task. This is discussed in further detail below.

It should be noted that although only a single DB 106 is illustrated in FIG. 1, the present disclosure is not so limited. For example, a plurality of databases may be deployed for one or more of the information described above that is stored.

In one embodiment, the communications network 100 may include one or more endpoint devices 108, 110, 112 and 114. The endpoint devices 108, 110, 112 and 114 may be located at a premise of an enterprise, located in different buildings of an enterprise or remotely located. In one embodiment, each of the endpoint devices 108, 110, 112 and 114 may be in different locations.

The one or more endpoint devices 108, 110, 112 and 114 may be any type of endpoint device capable of communicating with the IP network 102 and having a graphical user interface to create the work flows via the BPM platform. In one embodiment, the endpoint devices 108, 110, 112 and 114 may be a personal computer, a lap-top computer, a tablet device, a smartphone, a netbook, and the like. Although only four endpoint devices 108, 110, 112 and 114 are illustrated in FIG. 1, it should be noted that any number of endpoint devices may be deployed.

It should be noted that the network 100 has been simplified. For example, the network 100 may include other network elements (not shown) such as border elements, routers, switches, policy servers, security devices, a content distribution network (CDN) and the like. In addition, the network 100 may include additional networks between the endpoints (e.g., the endpoints 108, 110, 112 and 114) and the IP network 102 such as different access networks (e.g., wireless access networks, WiFi networks, cellular networks, cable networks, and the like) to reach the IP network 102.

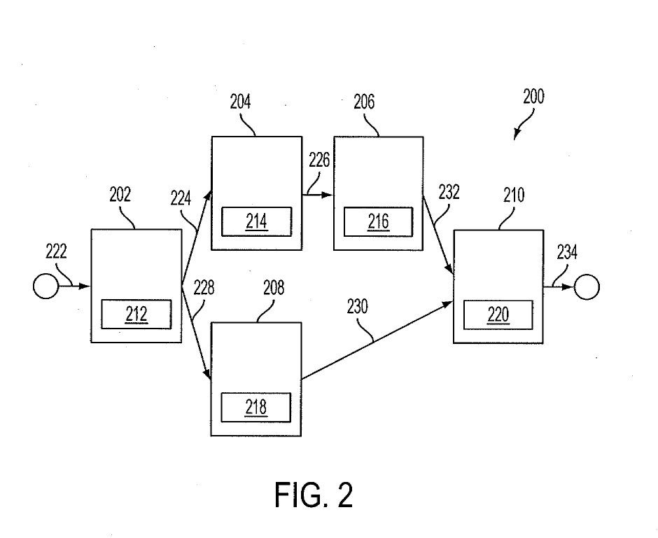

FIG. 2 illustrates one example of a work flow 200 that may be produced by the BPM platform via one of the endpoint devices 108, 110, 112 and 114. For example, a user on the endpoint device 108 may access the BPM platform on the AS 104 to create the work flow 200 using a graphical user interface. The work flow may comprise a plurality of components 202, 204, 206, 208 and 210. For example, a user may simply “drag and drop” various components selected from the components stored in the DB 106. Each one of the components 202, 204, 206, 208 and 210 may represent a service mapping and parameters that are stored in the DB 106 as discussed above.

In one embodiment, each one of the components 202, 204, 206, 208 and 210 may include an input, an output and a description. For example, the component 202 may include an input 222, outputs 224 and 228 and a description 212. The component 204 may include an input 224, an output 226 and a description 214. The component 206 may include an input 226, an output 232 and a description 216. The component 208 may include an input 228, an output 230 and a description 218. The component 220 may include inputs 232 and 230, an output 234 and a description 220.

In one embodiment, each of the components may be an automated task component or a human task component. For example, the components 202, 206 and 208 may be human task components and the components 204 and 210 may be automated task components.

Thus, the work flow 200 may represent a particular job broken down into individual components 202, 204, 206, 208 and 210 that include human task components and automated task components. Each one of the components 202, 204, 206, 208 and 210 may require a set of skills that may match a signature of the set of skills.

To illustrate by example, the work flow 200 may represent processing health care forms. The human task component 202 may receive the forms as an input and output unprocessed health care forms to the automated task component 204 and processed health care forms to the human task component 208. As a result, the human task component 202 may be described in a description as being able to read English and Spanish and separate the health care forms into the two groups of processed and unprocessed health care forms.

In one embodiment, the AS 104 using an extraction program, e.g., the BPM platform, may extract a set of skills based upon key words detected in the input, the output and the description. For example, the set of skills may include experience with health care forms, being fluent in English, being fluent in Spanish and having sorting skills. These extracted set of skills may be considered as required skills for the human task component 202. The extracted set of skills may then be matched against a signature having the same set of skills.

One example of calculating a signature may be performed by the following algorithm. Although, one example algorithm is provided below it should be noted that the present disclosure is not limited to any particular algorithm.

Step 1: Calculate the number of workers or employees (NSᵢ) who have skills Sᵢ, and sort NSᵢ from low to high using any sorting algorithm (e.g., a quick sort algorithm). The average time complexity of this step is o(n*m+m log m) and in the worst case o(n*m+m²).

Step 2: Starting from the lowest NSᵢ in the sorted list, repeat the following actions until all the skills have been processed. The worst time complexity of this step is o(n*m²). Starting from the lowest NSᵢ is based on the heuristic rule that skills with fewer owners have higher probabilities to differentiate.

Step 2.1: Cluster the workers with skill sᵢ into group k. The signature sigₖ is computed as a set of skills {sᵢ} where Sᵢ is selected if N_{k,i}/Nₖ>NSᵢ/n, where N_{k,i} is the number workers in the group k who have the skill Sᵢ, Nₖ is the number of workers in the group k, NSᵢ is the number of all workers who have the skill Sᵢ, and n is the total number of workers. As a result, dominant skills in a group are selected as the signature.

Step 2.2: Compare Sigₖ with the existing signatures iteratively until there is no Sigₖ⊂Sigₓ (Sigₓ⊂Sigₖ) nor Gₖ ∩ Gₓ≠φ. At each iteration, find the Sigₓ that are most similar to Sigₖ and do the following: If Sigₖ=Sigₓ, merge group Gₖ and Gpₓ. The skills sₖ and sₓ are relevant skills of this group. In one embodiment relevant skills may be found using a conditional probability. For example, a conditional probability is calculated for an employee having skills x and y and also having skill z. The conditional probability calculation would proceed iteratively until a majority of the employees cannot be found. If Sigₖ⊂Sig_{z}, merge Gₖ ∩ G_{z} with Gₓ, and Gₖ−(Gₖ ∩ Gₓ) becomes Gₖ with a new signature Sigₖ.

Step 3: For every skill compute the change ratio between NSᵢ and Gᵢ (or Gₖ that has Sᵢ in its relevant skill set) as NSᵢ−Gᵢ/NSᵢ. When the value is equal to or is less than a user defined threshold (by default 0), the corresponding Sᵢ is a common skill.

In one embodiment, the common skill may be defined as a skill possessed by a majority of the employees. In the worst case the computational complexity of step 3 is O(m).

In one embodiment, signatures may change as employees are added, subtracted or learn new skills. The changes may be performed dynamically at run time. For example, when worker “a” gains new skills, the method checks the impact on every signature. If these new skills are already contained in Sigₖ, Sigₖ does not change and the method simply updates the probability of k of worker “a” as described in step 2.1. Otherwise, the method needs to check whether Sigₖ needs to be changed using the method described in step 2.1, which will further trigger step 2.2. This may result in the generation of new signatures. When a new worker “b” with existing skills joins, for every skill of the worker “b,” the method computes its impact on the corresponding group. If it changes the signature, group splitting or merging happens as described in step 2.2.

With the precalculated signatures, the extracted set of skills may be matched to a precalculated signature. For example in one embodiment, skills can be sorted alphabetically and, thus, signatures may be organized in a forest (a list of search trees) where each node in a search tree represents a skill and a path from a root to a leaf represents a signature. When a task with skill and level requirements is submitted, the requirement is matched against signatures by traversing the search tree to reduce search spaces and returning top level employees.

In one embodiment, ReqS is used to indicate required skills. If ReqS ⊂̅Sig_{z} (the required skills is all or part of group x signature), the signature tree is traversed until the leaf node where ReqS is matched and returns one or more group identifications (IDs) in the same sub tree with ReqS as the root node, which are used to retrieve top level workers in this group.

If ReqS ⊂̅Sig_{z} ∩ . . . ∩ Sig_{y} (the required skills are the overlapped subset of multiple group signatures), the signature tree is traversed until an intermediate node where ReqS is matched and returns all the group IDs under this intermediate node. For example, the required skills may require skills A and D, signature 1 may have skills A, B and D and signature 2 may have skills A, C and D. Based on this example, the above algorithm may look to identify as candidates those employees that are in both signature 1 with skill A and signature 2 with skill D. Top level workers in these groups are recommended.

If ReqS⊂Sig_{z} ∪ . . . ∪ Sig_{y} (the required skills is the union of multiple group signatures), the signature tree is traversed until the longest signature in the union set is reached and its group ID is returned. For example, the required skills may require skills A, B, C and D, signature 1 may have skills A and B and signature 2 may have skills C and D. Based on this example, the above algorithm may look to identify as candidates those employees that are in both signature 1 with skills A and B and signature 2 with skills C and D if no single signature having skills A, B, C and D are found. Then top level workers with the exact matched skills are recommended.

Thus, in one embodiment, if no exact match between a required set of skills for a human task component and a single signature is found, a subset of overlapping signatures or a super set of a union of multiple signatures may be used. It should be noted that the above algorithm is only one example and other algorithms may be used to match a signature to a skill set extracted from the components 202, 204, 206, 208 and 210.

The above example algorithm provides a faster and more efficient computation due to the fact that the search set is greatly reduced by searching the precalculated signatures, as opposed to the entire roster of employees one-by-one, and due to the fact that some information is stored in memory during each iteration of the above algorithm. For example, the information may include the current signature and relevant skills of a group (the signature may be updated every time a new group is computed), the number of employees in a group and their IDs and for each skill in the signature, and for each skill of a signature the number of employees in the group who have the skill. For example, if the group's signature is x and y, the information would include the number of employees in the group who have skill x and the number of employees who have skill y.

For every iteration, these intermediate results may be cached into memory. Since the process only needs the intermediate results of the previous step, the memory space can be re-used. Therefore, the memory space usage does not significantly increase during the computation.

In addition, some global variable may be stored in cache memory. For example, the global variables may include a total number of employees (e.g., a number of all employees of an enterprise) and for every skill, a number of employees who have this skill. By storing this information in cache the time complexity of the above algorithm is linear, unlike currently used computations or methods.

For each one of the human task components 202, 206 and 208, embodiments of the present disclosure automatically attempts to find an employee based on a signature that matches a required set of skills associated with each one of the human task components 202, 206 and 208, as discussed above. If an employee is found from a grouping of employees having a signature that exactly matches the required set of skills, the employee is provided to the user as a recommendation to be assigned for the task or as a candidate to be hired for the task. In one embodiment, multiple employees may be provided to the user as recommendations and/or as possible candidates that they could be hired for the task.

If no exact match can be found, other employees with lower levels and or with fewer skills may be recommended based upon a probability score. In one embodiment, if a frequency of such occurrences exceeds a predefined threshold, hiring and/or training may be recommended. In one embodiment, the AS 104 may be configured to automatically search for hiring candidates that match the needed skills on third party websites such as LinkedIn® or Monster®.

In one embodiment, candidate employees for training may be identified as follows. Common skills may be removed from ReqS since these skills are easy to acquire by workers with different backgrounds. Common skills are those skills shared by employees having different backgrounds. Common skills may be calculated in one example as described above in step 3. Relevant skills in ReqS are identified and workers with complementary relevant skills are given higher priority.

If the needed skills ReqS⊂Sigₓ ∪ . . . ∪ Sig_{y}, employees in groups from x to y are selected and recommended back in the sequence of their closeness to ReqS defined as Σᵢ(Lᵢ) where Lᵢ is the level of skill sᵢ of a work flow and in sᵢ ∈ ReqS. If the needed skills ReqS⊂Sig_{z} ∩ . . . ∩ Sig_{y}, employees in the group z̅ with Sigᵢ as the shortened signature are selected. The intuition is that it takes shorter time and less effort to acquire a smaller number of skills. When the learning complexity of each skill is different, the method will select the group i with Sigᵢ, as the least complex skills to acquire which may not be the shorted signature.

Alternatively, if no exact match can be found the user may be requested to change the input, output or description of the human task component to improve the chances of finding an employee that matches the signature. In other words, the user may be requested to remove required skills to increase the probability that an employee matching the signature of the human task component may be found.

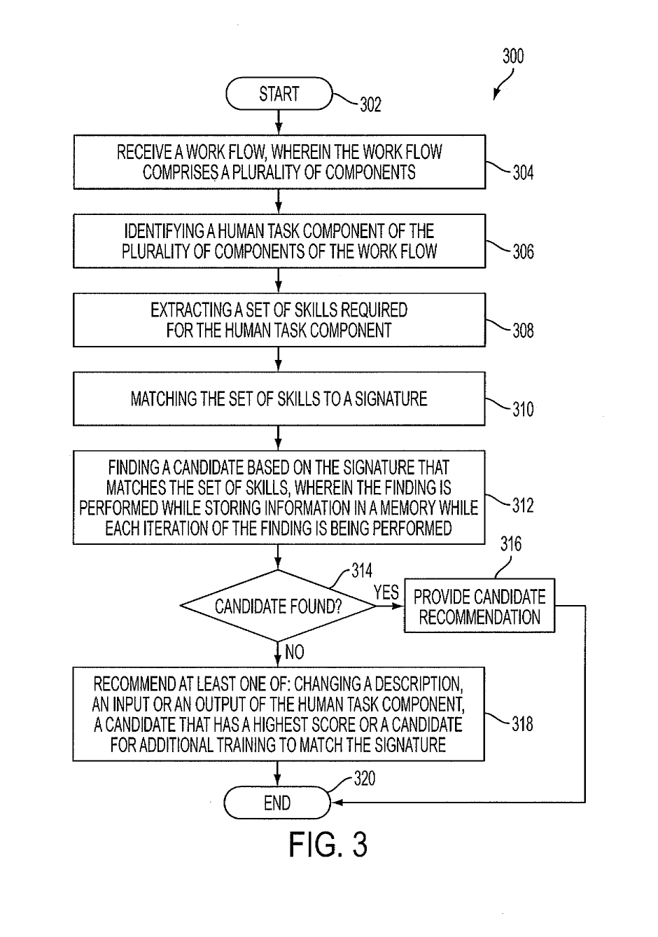

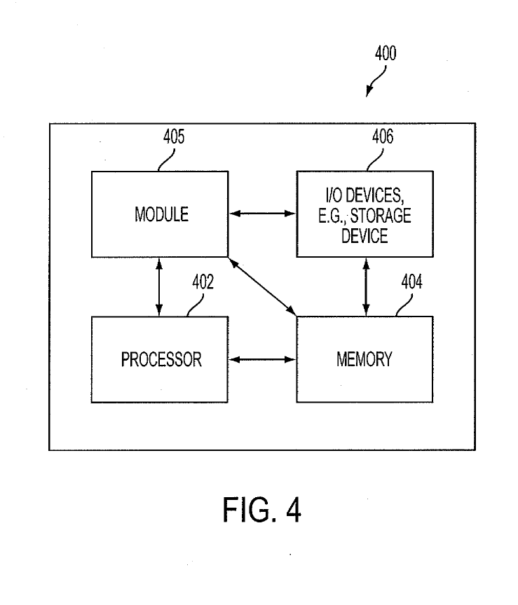

FIG. 3 illustrates a flowchart of a method 300 for performing competency management on a work flow. In one embodiment, the method 300 may be performed by the AS 104 or a general purpose computer as illustrated in FIG. 4 and discussed below.

The method 300 begins at step 302. At step 304, the method 300 receives a work flow, wherein the work flow comprises a plurality of components. For example, a user via an endpoint, e.g., endpoint 108 on FIG. 1, may access a BPM platform on the AS 104 to create a work flow. In one embodiment, the work flow may be created by simply dragging and dropping predefined service mappings and parameters of a component stored in the DB 106 via a graphical user interface.

At step 306, the method 300 identifies a human task component of the plurality of components of the work flow. As discussed above, the work flow may include human task components and automated task components. In one embodiment, each one of the service mappings and parameters selected by a user may be predefined as either a human task component or an automated task component.

At step 308, the method 300 extracts a set of skills required for the human task component. In one embodiment, each one of the components may include an input, an output and a description. The input, the output and the description may be analyzed to search for keywords that are associated with a particular skill. In one embodiment, a predefined table may be stored in the DB 106 that includes skills associated with various key words. It should be noted other methods or algorithms may be used to extract the skills based upon keywords found in the components of the work flow. In one embodiment, the extracted set of skills may be considered as the required set of skills for the human task component.

At step 310, the method 300 matches the set of skills to a signature. In one embodiment, the algorithms discussed above with respect to FIG. 2 may be used to obtain signatures that include a set of skills. In one embodiment, the signature may include common skills and relevant skills. In one embodiment, if an exact match to a signature cannot be found that matches a set of skills in the human task component, a subset of overlapping signatures or a super set of a union of multiple signatures may be used, as discussed above.

At step 312, the method 300 finds a candidate based on the signature that matches the set of skills. In one embodiment, the finding may be performed while storing information in a memory while each iteration of the finding is performed. As discussed above, the signatures may be precalculated and group employees based on their skills that are the same as the skills associated with the signature. As a result, in one embodiment, matching the signature to the set of skills that is required for the human task component provides a group of employees that could be recommended as possible candidates. The candidate may be selected from this group of employees associated with the signature that is matched to the set of skills. In one embodiment, more than one employee from the group of employees may be selected as possible candidates.

In one embodiment, the algorithm used to find a candidate is more efficient than what is currently available due to reduced search set from the use of the precalculated signatures, as opposed to searching the entire roster of employees one-by-one, and due to storage of information associated with each intermediate step of an iterative calculation. For example, the information may include the current signature and relevant skills of a group (the signature may be updated every time a new group is computed), the number of employees in a group and their IDs and for each skill in the signature, and for each skill of a signature the number of employees in the group who have the skill. For example, if the group's signature is x and y, the information would include the number of employees in the group who have skill x and the number of employees who have skill y.

Every iteration, these intermediate results may be cached into memory. Since the process only needs the intermediate results of the previous step, the memory space can be re-used. Therefore, the memory space usage does not significantly increase during the computation.

In addition, some global variable may be stored in cache memory. For example, the global variables may include a total number of employees (e.g., a number of all employees of an enterprise) and for every skill, a number of employees who have this skill. By storing this information in cache the time complexity of the above algorithm is linear, unlike currently used computations or methods.

At step 314, the method 300 determines if a candidate was found. If a candidate was found, then the method 300 proceeds to step 316. At step 316, the method 300 provides the candidate recommendation to the user. The method 300 proceeds to step 320 where the method 300 ends.

Referring back to step 314, if a candidate was not found, the method 300 proceeds to step 318. At step 318, the method 300 recommends at least one of: changing a description, an input or an output of the human task component, a candidate that has the highest score or a candidate for additional training to match the set of skills.

In one embodiment, changing the description, the input or the output allows the probability of finding a match to increase by reducing the number of required skills. In one embodiment, the candidate with the highest score may also include a probability score. In other words, the candidate is not an exact match to the signature, but matches a number of the required skills of the signature, which indicates a high probability of the candidate being able to complete the human task component. In one embodiment, the candidate for additional training may be determined based upon an example algorithm discussed above with reference to FIG. 2. The method 300 then proceeds to step 320. At step 320, the method 300 ends.

It should be noted that although not explicitly specified, one or more steps or blocks of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for performing competency management on a work flow, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 405 for performing competency management on a work flow can be loaded into memory 404 and executed by processor 402 to implement the functions as discussed above. As such, the present method or process 405 for performing competency management on a work flow (including associated data structures) of the present disclosure can be stored on a non-transitory (e.g., tangible or physical) computer readable storage medium, e.g., RAM memory, magnetic or optical drive or diskette and the like. For example, the processor 402 can be programmed or configured with instructions (e.g., computer readable instructions) to perform the steps of method 300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for performing competency management on a work flow, comprising:
receiving the work flow, wherein the work flow comprises a plurality of components;
identifying a human task component of the plurality of the components of the work flow;
extracting, via a processor, a set of skills required for the human task component;
matching, via the processor, the set of skills to a signature, wherein the signature comprises one or more skills and a group of employees, wherein each one of the group of employees has each one of the one or more skills of the signature, wherein the group of employees comprises a subset of all employees; and
finding, via the processor, a candidate from the group of employees of the signature based on the signature, having the one or more skills, that matches the set of skills.

2. The method of claim 1, wherein the plurality of components comprises automated task components and human task components.

3. The method of claim 1, wherein the identifying the human task component comprises identifying a plurality of human task components and wherein the extracting, the matching and the finding are performed for each one of the plurality of human task components.

4. The method of claim 1, wherein the extracting comprises identifying key words from a description, an input and an output of the human task component.

5. The method of claim 1, wherein the one or more skills of the signature comprise at least one of: a common skill or a relevant skill.

6. The method of claim 1, wherein the signature is precalculated.

7. (canceled)

8. The method of claim 1, wherein the finding is performed while storing information in a memory while each iteration of the finding is performed, wherein the information comprises the signature, a number of employees in a group and a number of employees who have a skill in the signature for each one of a plurality of skills in the signature.

9. The method of claim 1, further comprising:
if the candidate is not found, then recommending at least one of: changing a description, an input or an output of the human task component, a candidate that has a highest score, or a candidate for additional training to match the set of skills.

10. A non-transitory computer-readable medium having stored thereon a plurality of instructions, the plurality of instructions including instructions which, when executed by a processor, cause the processor to perform a method for performing competency management on a work flow, comprising:
receiving the work flow, wherein the work flow comprises a plurality of components;
identifying a human task component of the plurality of the components of the work flow;
extracting a set of skills required for the human task component;
matching the set of skills to a signature, wherein the signature comprises one or more skills and a group of employees, wherein each one of the group of employees has each one of the one or more skills of the signature, wherein the group of employees comprises a subset of all employees; and
finding a candidate from the group of employees of the signature based on the signature, having the one or more skills, that matches the set of skills.

11. The non-transitory computer-readable medium of claim 10, wherein the plurality of components comprises automated task components and human task components.

12. The non-transitory computer-readable medium of claim 10, wherein the identifying the human task component comprises identifying a plurality of human task components and wherein the extracting, the matching and the finding are performed for each one of the plurality of human task components.

13. The non-transitory computer-readable medium of claim 10, wherein the extracting comprises identifying key words from a description, an input and an output of the human task component.

14. The non-transitory computer-readable medium of claim 10, wherein the one or more skills of the signature comprise at least one of: a common skill and a relevant skill.

15. The non-transitory computer-readable medium of claim 10, wherein the signature is precalculated.

16. (canceled)

17. The non-transitory computer-readable medium of claim 10, wherein the finding is performed while storing information in a memory while each iteration of the finding is performed, wherein the information comprises the signature, a number of employees in a group and a number of employees who have a skill in the signature for each one of a plurality of skills in the signature.

18. The non-transitory computer-readable medium of claim 10, further comprising:
if the candidate is not found, then recommending at least one of: changing a description, an input or an output of the human task component, a candidate that has a highest score, or a candidate for additional training to match the set of skills.

19. A method performing competency management on a work flow, comprising:
precalculating a plurality of signatures, wherein each one of the plurality of signatures comprises one or more skills, wherein the one or more skills comprise at least one of a common skill or a relevant skill and a group of employees having each one of the one or more skills of the signature, wherein the group of employees comprises a subset of all employees, wherein the common skill is identified based upon a number of employees having a particular skill that is greater than a predefined threshold and the relevant skill is identified using a conditional probability calculation;
receiving the work flow, wherein the work flow comprises a plurality of components;
identifying a human task component of the plurality of the components of the work flow;
extracting, via a processor, a set of skills required for the human task component based upon key words identified from a description, an input and an output of the human task component;
matching, via the processor, the set of skills to one of the plurality of signatures; and
finding, via the processor, a candidate from the group of employees in the signature, having the one or more skills, that matches the set of skills using an iterative process, wherein the finding is performed while storing the signature, a number of employees in a group and a number of employees who have a skill in the signature for each one of a plurality of skills in the signature in a memory while each iteration of the finding is performed.

20. The method of claim 19, further comprising:
if the candidate is not found, then recommending at least one of: changing the description, the input or the output of the human task component, a candidate that has a highest score, or a candidate for additional training to match the set of skills.
